(19) United States
(12) Patent Application Publication
(10) Pub. No.: US 2002/0087492 A1
(43) Pub. Date: Jul. 4, 2002

(54) Method and system for postage meter accounting utilizing a web browser in a postal or shipping system

(75) Inventors: Terri A. Carroll, Trumbull, CT (US); David A. Ellis, Wallingford, CT (US); Jacques E. Hasbani, Easton, CT (US)

Correspondence Address: Paul A. Levitsky, Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 09/748,890

(22) Filed: Dec. 27, 2000

(51) Int. Cl. G06F 17/60

(52) U.S. Cl. 705/404; 705/30

(57) ABSTRACT

The invention is a method and system for postage meter cost accounting using a web browser based postal mail shipping system. The data processing systems comprise a web site for a provider server and a client node in communication with the provider server. The web site further comprises web pages and script functionality for linking with a meter driver resident in a meter located at the client node, but callable by the client node under the control of the script functionality for allowing the script at the client node to link with the meter by utilizing the meter driver. The method is initiated by calling a web site from the caller node by utilizing communications link, which includes a browser for accessing the web site. The client node requests that a meter activation routine be activated. Cost accounting data is stored in a cost accounting meter table on a database server. User selects an account from the cost accounting table, mail transactions are performed, and the cost accounting table is updated with the transaction information.

### RELATED APPLICATIONS

Reference is made to application Ser. No. ______ (Attorney Docket No. F-112) entitled “A Method And System For Batch Mail Processing Utilizing A Web Browser In A Postal Or Shipping System” assigned to the assignee of this application and filed contemporaneously hereto.

Reference is made to application Ser. No. ______ (Attorney Docket No. F-113) entitled “A Method And System For Preparing And Distributing Carrier Delivery Confirmation Via The Web” assigned to the assignee of this application and filed contemporaneously hereto.

Reference is made to application Ser. No. ______ (Attorney Docket No. F-114) Entitled “A Method And System For Refilling A Meter With Postage Over The Internet” assigned to the assignee of this application and filed contemporaneously hereto.

Reference is made to application Ser. No. ______ (Attorney Docket No. 115) entitled “A Method And System for Postage Meter Asset Management Using A Web Browser Based Postal Mail Shipping System” assigned to the assignee of this application and filed contemporaneously hereto.

### FIELD OF THE INVENTION

The present invention relates generally to the field of mail piece and/or parcel processing in a network and, more specifically, to the field of meter asset management functionality integrated within an Internet or intranet data processing environment. Specifically, the present invention provides a method and system for postage meter cost accounting in a web-based system.

### BACKGROUND OF THE INVENTION

Business planning and organization often depends upon the ability of systems to accurately process up-to-date information. This processing includes the management of information, which enables the daily operations of the business and includes such functions as accounting for operational funds including funds used for postal processing. Businesses, large and small, require the same understanding as to where and how funds are used within the business. Firms may separate their mailroom operations by department, division or a variety of organizational units, each of which requires authorized transfer of postal funds to transact daily business. In managing a firm's assets, it has become important for firms to account for all used funds, including postage meter funds used by the individual organizations or employees within a firm. This includes enabling cost accounting of postal funds debited from all meters in a firms.

Postal processing can be described as two distinctive areas: shipping/carrier and mailing systems. Both systems require the application of funds in order to enable postal processing.

Systems that allow the user to process parcels for delivery by a carrier are known as “shipping systems”; or, if the intent of the system is to allow the user to choose from among the services of more than one carrier, the system may be known as a “carrier management system”. Carrier management systems are referred to as “shipping systems” and are designed to prepare parcels in accordance with the regulations of the carrier that will be transporting the parcels for later delivery. Systems that allow the processing and delivery of individual mail pieces are generally referred to as “mailing systems”. Mailing systems may simply include a postage meter for printing postage payment evidencing on an envelope; or, they may be sophisticated systems for complete mail piece processing. These systems may include a scale for weighing the mail piece and for determination of the postage amount. In addition, these systems may integrate the ability to print and personalize a document, match an envelope to the document, include preprinted sheets, with the mail piece, accumulate, fold and insert the completed mail piece into an envelope to be sealed.

Traditional configurations of shipping include low-end embedded systems; mid-range personal computer-(PC) based systems; and upper and mid-mainframe-based systems.

Embedded systems, where the shipping application is embedded within a shipping scale, generally include PROM-based rating tables and their associated functionality. Data entries to the application are made via an operator keypad on the front of the scale or by scanning bar codes or similar symbology directly to certain fields within the application. Table data and certain rating functionality are generally added through the use of PROM's. These systems might also interface to a postage meter for producing proof of payment for a carrier such as the United States Postal Service (USPS).

PC-based systems are more flexible than embedded systems because they allow a greater range of peripherals, greater memory capability, networking capabilities via the Internet or an intranet, and the ability to store records and addresses lists while accepting data download in a variety of ways. Rating and services functionality are also directed from the application, while the system shops for an appropriate rate from a database residing in a memory contained within a PC or from a rating table directed by a server. Address lists can be stored or forwarded as well. The ability of the PC-based system to provide a communications link to a network while allowing integration with a client's information systems is perhaps the greatest strength of these systems. Network links via the Internet provide the system with an interface to a greater number and variety of carriers' web sites, increased functionality, and parcel tracking. Additionally, data relevant to shipping history for a particular location or historical manifest data can be downloaded or uploaded in a quick and efficient manner as necessary.

The PC-based systems offer much the same functionality as the upper end and mid main frame systems. The upper systems, however, offer the advantage of exceptional processing speed while handling large volumes of transaction data or performing multi-tasking of application services, as well as application level integration with client systems.

Traditional mailing systems include dedicated systems used for metering or integrated systems including PC processing in which a document may be created and metered for delivery. These systems have been designed to service the small and large office based in part on volume and processing requirements. For example, some mailing systems may include only a meter for marking a mail piece with a designated amount of postage, while other systems couple the meter to a scale which enables automatic application of postal rate requirements. Still other mailing systems include a PC for enabling document creation, printing and enveloping before applying metered evidence of postage payment.

Shipping and mailing systems have both benefited from the efficiencies associated with PC-based systems and applications. Labels can be printed at the desktop; weighing scales are interconnected to PC's for inputting weight to parcel shipping applications; and manifests for recording the details of parcel pickup and delivery are printed at the desktop as well. Furthermore, document creation, address cleansing and, in general, mail processing have also been advanced with the use of a PC. Address peripherals, such as postage meters for payment evidencing, and other input devices can also be added for increased data delivery.

In an enterprise environment which employs PC-based shipping or mailing systems serving as a stand alone system, or one that is part of a local area network (LAN), or even a wide area network (WAN), the ability to account for meter assets has become important. In other words, firms have become highly concerned with accounting for postage meter fund usage. One system that has addressed this issue, ASCENT®, is commercially available from Pitney Bowes Inc., of Stamford, Conn. The ASCENT® system is a dedicated system that offers multi-carrier automated processing designed to maximize the productivity of mail or shipping room centers.

ASCENT® manages mail, small parcel, air express, international, and regional or courier services in one system. The system includes delivery confirmation support, cost-saving electronic data transmission, integrated tracking, and barcode label printing. Also provided is differential weighing, which provides efficient processing of mixed weight envelopes and flats. As well, the system automates processing of certified mail and return receipt forms.

Currently, however, there exists no effective way to provide a postage meter cost accounting system using an Internet browser for Internet-based applications being directed from a server. A browser-based system would eliminate the requirement for dedicated systems, thus enabling a broader range of customer access to both the shipping/carrier and mailing systems. Furthermore, a browser based system would provide an easily scalable solution to both small businesses and large enterprise environments. Browser based systems are also less expensive because very little custom software is required at the client. Therefore, a method and system are required that allow a system user to manage meter asset functionality directly from an Internet or intranet-based application, while utilizing a browser.

### SUMMARY OF THE INVENTION

present invention provides a web-based shipping and mailing application for supporting meter cost accounting operations while maintaining functionality similar to PC-based applications. In the present invention, a meter cost accounting operation is integrated within an Internet web browser which enables greater populations to enjoy the benefits and advantages of metered mail. The invention is designed to be scalable to both homes and small business as well as large distributed enterprises due to the low cost and ease of the distribution of the system compounded by the low cost of maintaining the system.

A postage meter/mailing machine is operatively connected to a personal computer or Internet appliance, i.e., the client. The client is running an Internet web browser and is connected to the Internet or a corporate intranet. There is also a driver running on the client for communicating with the meter. The client connects to the web server over the Internet or intranet. The server, which contains all the software necessary to support traditional mailing and shipping applications, is running the web-based shipping and mailing application. Such software is known generally in the art of mailing and shipping systems and is capable of supporting, for example, Meter Cost Accounting, Rating, User Information, etc. The centralization of this sophisticated software also enables a reduction in cost to the user.

The system of the present invention comprises a web site for a provider server and a client node in communication with the provider server. The web site further comprises provider web pages and script functionality resident in the provider web pages for linking with a meter driver resident in a client computer that is in communication with a meter attached at the client node. The client node can be one of a plurality of client nodes that is linked to the system. At least one client must be operatively connected to a meter.

The meter at the client node further comprises: a meter driver; a meter server resident first at the client computer but callable under control of the script functionality; and, script activation capability for allowing the script at the web site to link with the meter by utilizing the meter driver.

The method is initiated by calling a web site associated with the provider server from the client node by utilizing a communications link for linking the web sites and the meter at the client node. The communications link comprises: a browser for accessing the web site by the client node; a network interface routine for allowing access to a network wherein the web site resides; and communications means for physically interfacing the meter with the client node and ultimately with the network itself.

The client node requests that a meter activation routine be activated at the web site for download to the client. The routine includes the use of script (such as JAVASCRIPT™ commercially available from Sun Microsystems, Inc. of Palo Alto, Calif.) to call an ACTIVE X™ automation server. ACTIVE X™ is a set of integration technologies that enables software components to inter-operate in a networked environment using any programming language. A list of accounts is then displayed, and a user selects an account number for which transactions are to charged. Meter transactions are then performed, and data is obtained from the meter; representative data includes batch count, values, and piece count. The cost accounting table located on the web server is updated to reflect the amount spent by the unit. The updated information may then be transferred directly to the user's accounting system. This may be done via file transfer use of an (XML) intended markup language, screen scraping, or application program interface (API).

### BRIEF DESCRIPTION OF THE DRAWINGS

FIG. 1 is a block diagram of the overall system of the present invention.

FIG. 2A is a flowchart of the method of the present invention.

FIG. 2B is a continuation of the flowchart of FIG. 2A which illustrates the method of the present invention.

### DETAILED DESCRIPTION OF THE EMBODIMENTS

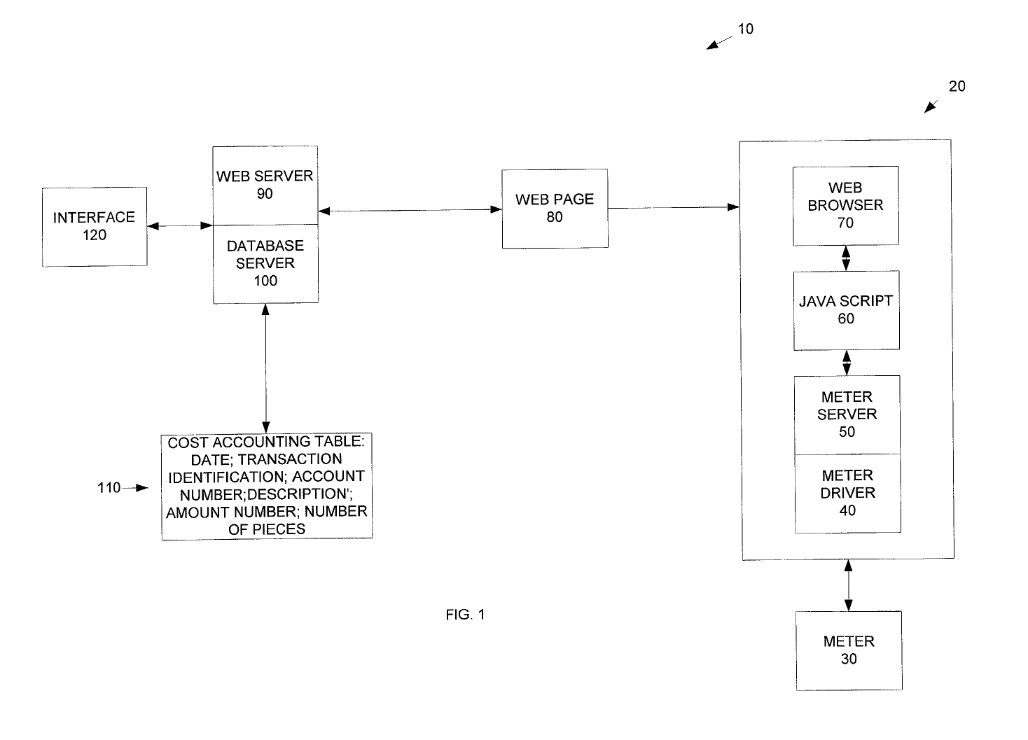

Now turning to FIG. 1, there is shown a block diagram of system 10 of the present invention showing the system flow between each of the high-level components situated in either an Internet or an intranet environment. System 10 includes client computer 20, which may be a PC or a thin client network computer such as a PALM PILOT™ available commercially from 3Com of Santa Clara, Calif. Client computer 20 is operatively connected to meter 30 (which can be a postage meter) through a communications cable such as an RS232 protocol cable. Client computer 20 (also PC 20) further includes web browser 70 (also known as a web client).

A web browser is software that makes it easy to access information on the Internet. Browser software interprets the Hyper Text Markup Language (HTML) codes in web pages so that the pages can be viewed in a readable format. The browser software enables a specific connection to a network address called a Uniform Resource Locator (URL), which sends a request to web server 90 for that particular addressed document, i.e.: web page 80. Web server 90 responds by sending to web page 80 text and/or other media such as video and/or audio for use by PC 20. Web page 80 is sent in the HTML format. A scripting language such as JAVASCRIPT™, enables communication between the application and meter server 50. Meter server 50 is an application program which provides an interface to script 60 such that a script call can then perform certain functions. Web server 90 also may provide an interface 120 with customer accounting system (not shown) and enables transfer of account data through terminal emulation, file transfer, XML, API or any other means of transferring data to an accounting system.

JAVASCRIPT™ is a compact, object-based scripting language for developing client and server Internet applications. JAVASCRIPT™ is included in web pages and run with a web browser. In addition, JAVASCRIPT™ can implement programmer-defined functions, which can create interactive client side pages.

Meter server 50 and meter driver 40 enable communication using JAVASCRIPT™ between meter 30 and Browser 70. Communication may be accomplished using object-oriented programming. Object oriented design (OOD) programming languages are useful in removing some of the restrictions that have hampered application design due to the inflexibility of traditional programming languages.

OOD utilizes a basic element or construct known as the “object,” which combines both a data structure and an intended behavior characteristic within the single element. Objects are bundles of data and the procedures which best identify the use of that data. Objects can be specific or conceptual and are often used to represent models of real-world object groupings; this has the effect of helping software applications become an organized collection of discrete objects in which data is held or moved based on the intended behavior of an object which is inherently unique. Each object knows how to perform some activity.

The objects interact and communicate with each other via messages. A message is initiated by one object for the purpose of getting a second message to perform an act such as performing the steps of a method. Information parameters may be passed along with the message so that the receiving object will have guidelines for performing its action. OOD is known in the art of computer programming; therefore, a detailed description is not necessary for an understanding of this invention.

Returning to FIG. 1, web server 90 communicates with database server 100 using a server side scripting language and or data base objects, which in turn communicates with at least one cost accounting table 110. Cost accounting table 110 includes data such as, for example: the date, transaction identification, account number, description, account, and the total count of pieces processed by meter 30. Cost accounting table 110 may be separated into two tables: a meter table and an account table. The meter table would include the date, transaction identification, amount number and number of pieces. The account table would include an account number and a description.

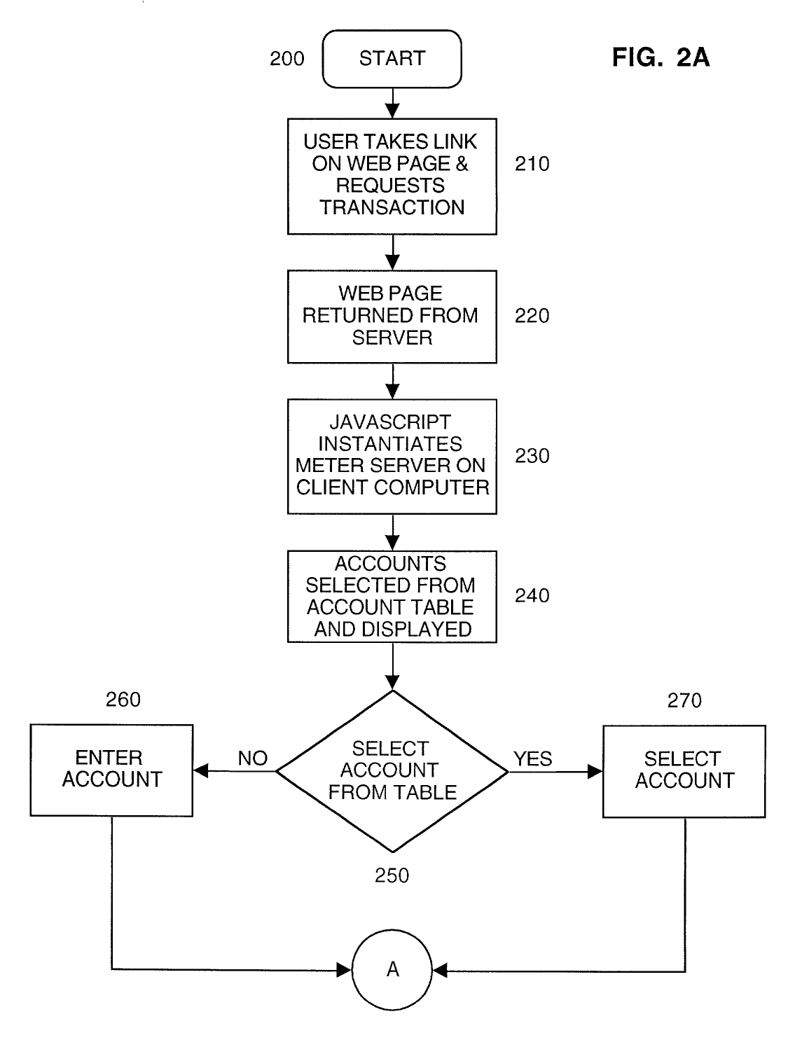

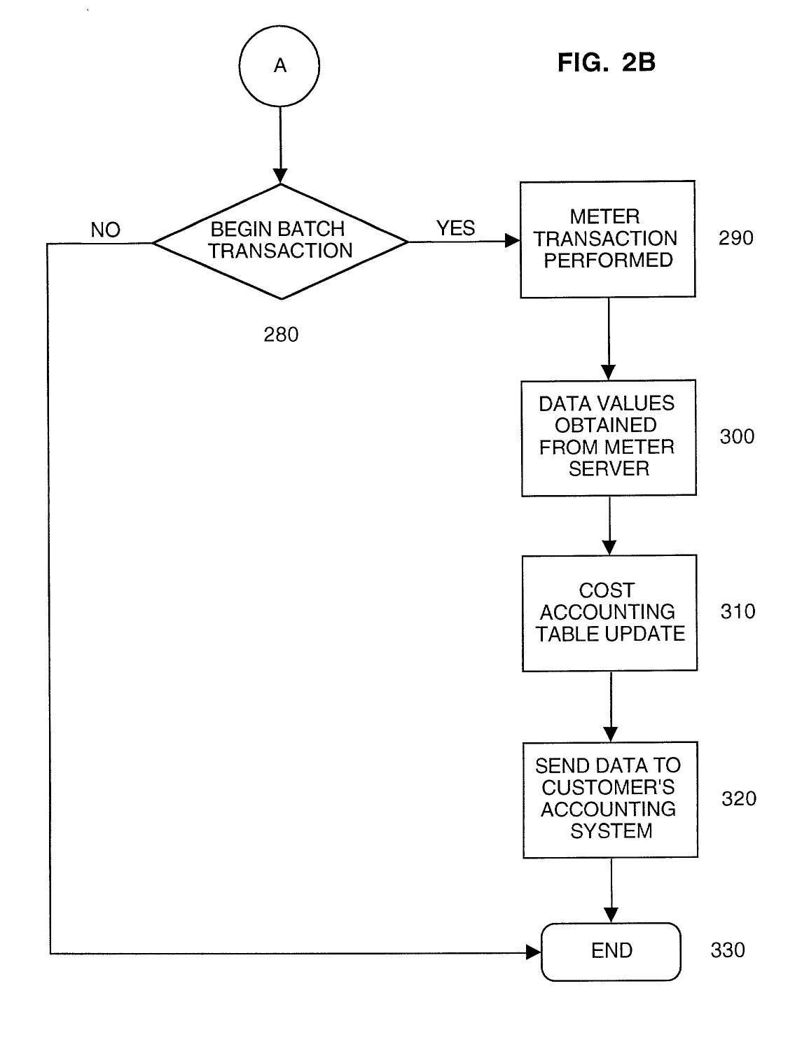

Now turning to FIG. 2A, there is shown a flowchart of the operation of the cost accounting system of the present invention. The method begins at step 200 where the user initiates the system. The user requests the appropriate web page 80 by inputting the associated URL at step 210. The method advances to step 220 where web page 80 is returned to PC 20 from web server 90.

The method then advances to step 230 where JAVASCRIPT™ 60 instantiates meter server 50 on client computer 20 before continuing to step 240. At step 240, accounts are selected from the account table and displayed before advancing to step 250 where the system queries as to whether or not the user will select an account from the account table 110. If the answer to the query is “YES,” then the method proceeds to step 270 where the user selects the account number before proceeding along path A to step 280 as is shown in FIG. 2B. If, however, the answer to the query at step 250 is “NO,” then the method progresses to step 260 where the user manually enters an account number before advancing along path A.

Now turning to FIG. 2B the method re-enters the path at connector A and progresses to step 280 where the method queries as to whether or not to begin a batch transaction. If the answer to the query is “YES”, then the method continues to step 290 where the meter transaction is performed. If, however, the answer to the query is “NO,” then the method ends at step 330.

From step 290, the method advances at step 280 to step 300. At step 300, data values are obtained from the meter server, such as batch, count, batch value, piece count, postage, etc. Batch is a group of mail pieces being processed at the same time against the same account number. Batch Count is the number of mail pieces in the batch. Batch Value is the total value of the postage in the batch of mail. Piece Count is the total number of mail pieces processed. Postage is the postage of each piece of mail processed.

The method then advances to step 310. At step 310, the cost accounting table is updated, and then at step 320, the data is sent to the customer's accounting system. The method ends at step 330. The web server updates the cost accounting tables with the transaction data and time, transaction identification, an account number, description, the amount of the transaction, and the number of mail pieces processed. The transaction may then be sent to the customer's account system via XML, terminal emulation, API or any other appropriate means of data transfer.

The above specification describes a new and improved system and method for automatically transferring information in a data processing system. It is realized that the above description may indicate to those skilled in the art additional ways in which the principles of this invention may be used without departing from the spirit of the invention. It is, therefore, intended that this invention be limited only by the scope of the appended claims.

What is claimed is:

1. A method for meter cost accounting using a web browser-based shipping system comprising the steps of:
(a) operatively connecting a meter to a client for enabling said meter to perform a transaction;
(b) running a web browser program on said client for communicating with a web server;
(c) running a meter application on said web server;
(d) identifying a user account;
(e) performing said transaction; and
(f) updating a cost accounting table located on the web server with said transaction information relative to said user account.

2. The method of claim 1, further comprising the step of transferring transaction information to a customer accounting system.

3. The method of claim 2, wherein said transfer is completed through extended markup language.

4. The method of claim 2, wherein said transfer is completed through scraping.

5. The method of claim 1, wherein said cost accounting table further comprises a meter table and an account table.

6. A method for postage meter cost accounting using a web browser based shipping system comprising the steps of:
(a) operatively connecting a postage meter to a client;
(b) running a web browser program on said client for communicating with a web server;
(c) running a postage meter application on said web server;
(d) running a postage meter automation server on said client;
(e) communicating between said automation server and said web server using a script call;
(f) identifying a user account;
(g) performing a transaction; and
(h) updating a cost accounting table with information relative to said transaction.

7. The method of claim 6, wherein said script call is JAVASCRIPT™.

8. The method of claim 6, further comprising the step of transferring transaction information to a customer accounting system.

9. The method of claim 6 wherein said transfer is completed through extended mark up language.

10. The method of claim 6 wherein said transfer is completed by scraping.

11. The method of claim 5, wherein said cost accounting table further comprises a meter table and an account table.

12. A system for postage meter cost accounting using a web browser based postal mail shipping system comprising:
(a) a postage meter operatively connected to a client for performing a meter transaction;
(b) a web browser program running on said client for communicating with a web server; and
(c) a postage meter application running on said web server, said postage meter application updating a cost accounting table with said information relative to said postage meter transaction;
(d) identifying a user account;
(e) performing said transaction; and
(f) updating said cost accounting table with said transaction information.

13. The system of claim 12 further including a means for transferring information to a customer cost accounting system.

14. The system of claim 13 wherein said transfer is completed through extended mark up language.

15. The system of claim 13 wherein said transfer is completed by scraping.

16. The system of claim 12, wherein said cost accounting table further comprises a meter table and an account table.
